(19) United States
(12) Patent Application Publication
(10) Pub. No.: US 2020/0194827 A1
(43) Pub. Date: Jun. 18, 2020

(54) SULFIDE-BASED SOLID ELECTROLYTE DOPED WITH ALKALINE EARTH METAL AND METHOD OF MANUFACTURING THE SAME

(71) Applicants: Hyundai Motor Company, Seoul (KR); KIA Motors Corporation, Seoul (KR)

(72) Inventors: Ju Yeong SEONG, Hwaseong-si (KR); In Woo SONG, Gwacheon-si (KR); Hong Seok MIN, Yongin-si, (KR); Yong Jun JANG, Seongnam-si, (KR); Yun Sung KIM, Seoul (KR); Dong Wook SHIN, Seongnam-si (KR); Chan Hwi PARK, Seoul (KR); Sang Soo LEE, Goyang-si (KR); Kyu Beom KIM, Seoul (KR)

(73) Assignee: Industry-University Cooperation Foundation Hanyang University, Seou (KR)

(21) Appl. No.: 16/664,070

(22) Filed: Oct. 25, 2019

(30) Foreign Application Priority Data
Dec. 18, 2018 (KR) 10-2018-0163722

(51) Int. Cl. H01M 10/0562; C01B 17/42

(52) U.S. Cl. CPC H01M 10/0562; C01B 17/42; C01P 2006/40; C01P 2002/72; H01M 2300/008

(57) ABSTRACT

The present disclosure relates to a sulfide-based solid electrolyte doped with an alkaline earth metal for improving the ionic conductivity thereof and a method of manufacturing the same. The sulfide-based solid electrolyte is represented by Chemical Formula 1 below. The sulfide-based solid electrolyte exhibits high voltage stability and ionic conductivity. Consequently, it is possible to obtain an all-solid-state battery having a large capacity and stable behavior using the sulfide-based solid electrolyte.

Li₆₋₂ₓMeₓPS₅Ha [Chemical Formula 1]
wherein Me is an alkaline earth metal element, Ha is a halogen element, and 0<x≤0.5.

### CROSS-REFERENCE TO RELATED APPLICATION

This application claims the benefit of and priority to Korean Patent Application No. 10-2018-0163722, filed on Dec. 18, 2018, the entire contents of which are incorporated herein by reference.

### FIELD

The present disclosure relates to a sulfide-based solid electrolyte doped with an alkaline earth metal for improving the ionic conductivity thereof and a method of manufacturing the same.

### BACKGROUND

The statements in this section merely provide background information related to the present disclosure and may not constitute prior art.

Secondary batteries have come to be widely used for large-sized devices, such as vehicles and power storage systems, as well as small-sized devices, such as mobile phones, camcorders, and laptop computers.

As devices to which the secondary batteries are applicable are becoming more diverse, the demand for improving the safety and performance of the batteries has increased.

A lithium secondary battery, which is one of the secondary batteries, exhibits higher energy density and capacity per unit area than a nickel-manganese battery or a nickel-cadmium battery.

However, in most cases, a liquid electrolyte, such as an organic solvent, is used in such a lithium secondary battery. For this reason, the electrolyte may leak from the lithium secondary battery, and the lithium secondary battery may catch fire due to leakage of the electrolyte.

In recent years, therefore, an all-solid-state battery using a solid electrolyte instead of the liquid electrolyte in order to improve the safety of the lithium secondary battery has attracted considerable attention.

The solid electrolyte exhibits incombustibility or flame retardation. Consequently, the safety of the solid electrolyte is higher than that of the liquid electrolyte.

The solid electrolyte is classified as an oxide-based solid electrolyte or a sulfide-based solid electrolyte. The sulfide-based solid electrolyte has higher lithium ionic conductivity than the oxide-based solid electrolyte, and is stable in a larger voltage range. For these reasons, the sulfide-based solid electrolyte is mainly used.

In recent years, research has been actively conducted on a sulfide-based solid electrolyte having an argyrodite-based crystalline structure that is easily compounded and exhibits high ionic conductivity, as disclosed in International Patent Application Publication No. WO 2016/009768 and International Patent Application Publication No. WO 2009/047254.

The above information disclosed in this Background section is provided only for enhancement of understanding of the background of the disclosure and therefore it may contain information that does not form the prior art that is already known in this country to a person of ordinary skill in the art.

### SUMMARY

The present disclosure provides a sulfide-based solid electrolyte having high voltage stability and ionic conductivity and a method of manufacturing the same.

The present disclosure provides a sulfide-based solid electrolyte that has never been reported before and a method of manufacturing the same.

The present disclosure is not limited to those described above. The present disclosure will be understood from the following description and could be implemented by means defined in the claims and a combination thereof.

In one aspect, the present disclosure provides a sulfide-based solid electrolyte represented by Chemical Formula 1 below.

Li₆₋₂ₓMeₓPS₅Ha [Chemical Formula 1]

wherein Me is an alkaline earth metal element, Ha is a halogen element, and 0<x≤0.5.

The sulfide-based solid electrolyte may include a crystalline phase having an argyrodite-based crystalline structure.

The Me may be an alkaline earth metal element selected from the group consisting of Ca, Mg, and a combination thereof.

The Ha may be a halogen element selected from the group consisting of Cl, Br, and a combination thereof.

In another aspect, the present disclosure provides an all-solid-state battery including a positive electrode, a negative electrode, and a solid electrolyte layer disposed between the positive electrode and the negative electrode, wherein at least one of the positive electrode, the negative electrode, and the solid electrolyte layer includes the sulfide-based solid electrolyte.

In a further aspect, the present disclosure provides a method of manufacturing a sulfide-based solid electrolyte, the method including preparing a mixture of lithium sulfide, phosphorus pentasulfide, and a compound selected from the group consisting of a halogen compound, an alkaline earth metal compound, and a combination thereof, pulverizing the mixture, and thermally treating the pulverized mixture.

The halogen compound may be LiHa, and the Ha may be a halogen element selected from the group consisting of Cl, Br, and a combination thereof.

The alkaline earth metal compound may be MeHa₂ or MeS, the Me may be an alkaline earth metal element selected from the group consisting of Ca, Mg, and a combination thereof, and the Ha may be a halogen element selected from the group consisting of Cl, Br, and a combination thereof.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a graph showing the results of X-ray diffraction analysis of sulfide-based solid electrolytes according to Examples 1 to 5 and Comparative Example;

FIG. 2 is a graph showing the results of X-ray diffraction analysis of sulfide-based solid electrolytes according to Examples 6 to 9 and Comparative Example;

FIG. 3 is a graph showing the results of X-ray diffraction analysis of sulfide-based solid electrolytes according to Examples 10 to 16 and Comparative Example;

FIG. 4 is a graph showing the results of measurement of the ionic conductivities of the sulfide-based solid electrolytes according to Examples 1 to 16 and Comparative Example;

FIG. 5 is a graph showing the results of evaluation of the voltage stability of the sulfide-based solid electrolyte according to Example 11;

FIG. 6 is a graph showing the results of measurement of the capacity of an all-solid-state battery including the sulfide-based solid electrolyte according to Example 11; and

FIG. 7 is a graph showing the results of measurement of the lifespan of the all-solid-state battery including the sulfide-based solid electrolyte according to Example 11.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

It will be understood that the terms “comprises”, “has” and the like, when used in this specification, specify the presence of stated features, numbers, steps, operations, elements, components or combinations thereof, but do not preclude the presence or addition of one or more other features, numbers, steps, operations, elements, components, or combinations thereof.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all numbers, figures and/or expressions. In addition, when numeric ranges are disclosed in the description, these ranges are continuous and include all numbers from the minimum to the maximum including the maximum within the range unless otherwise defined. Furthermore, when the range refers to an integer, it includes all integers from the minimum to the maximum including the maximum within the range, unless otherwise defined.

A sulfide-based solid electrolyte according to the present disclosure is a compound represented by Chemical Formula 1 below.

Li₆₋₂ₓMeₓPS₅Ha [Chemical Formula 1]

wherein Me is an alkaline earth metal element, Ha is a halogen element, and 0<x≤0.5.

Me may be an alkaline earth metal element selected from the group consisting of beryllium (Be), magnesium (Mg), calcium (Ca), strontium (Sr), barium (Ba), radium (Ra), and combinations thereof. Me may be an alkaline earth metal element selected from the group consisting of Ca, Mg, and a combination thereof.

The sulfide-based solid electrolyte according to the present disclosure is characterized in that the sulfide-based solid electrolyte is doped with the alkaline earth metal element. In this specification, “doping” means that at least one element of a compound is substituted by a new element and that the doped element becomes a component of a crystalline phase of a compound.

Specifically, in the present disclosure, a sulfide-based solid electrolyte represented by Li₆PS₅Cl is doped with an alkaline earth metal element. Since a single-valence lithium element is substituted by a two-valence alkaline earth metal element (2Li⁺→Me²⁺), a lithium vacancy is formed in the sulfide-based solid electrolyte. As a result, lithium ions more smoothly move through the sulfide-based solid electrolyte, whereby the sulfide-based solid electrolyte exhibits high ionic conductivity.

x indicates the amount of the alkaline earth metal element that is doped, in moles. x satisfies 0<x≤1.5. If x exceeds 0.5, the crystalline structure of the sulfide-based solid electrolyte may be deformed, and the movement of lithium ions may be impeded.

Ha may be a halogen element selected from the group consisting of fluorine (F), chloride (Cl), bromine (Br), iodine (I), and combinations thereof. Ha may, in one aspect, be selected from the group consisting of Cl, Br, and a combination thereof.

The sulfide-based solid electrolyte may include a crystalline phase having an argyrodite-based crystalline structure. Since the sulfide-based solid electrolyte according to the present disclosure, represented by Chemical Formula 1 above, does not include phases other than the crystalline phase having the argyrodite-based crystalline structure, the ionic conductivity thereof is high.

A method of manufacturing the sulfide-based solid electrolyte according to the present disclosure, represented by Chemical Formula 1 above, includes a step of preparing a mixture of raw materials, a step of pulverizing the mixture, and a step of thermally treating the pulverized mixture.

The raw materials include lithium sulfide (Li₂S), phosphorus pentasulfide (P₂S₅), and a compound selected from the group consisting of a halogen compound, an alkaline earth metal compound, and a combination thereof.

The raw materials may be weighed and mixed based on the desired composition of the sulfide-based solid electrolyte in order to obtain an appropriate mixture.

In the case in which the alkaline earth metal compound is a halogenated compound of an alkaline earth metal, the halogen compound may not be used, depending on the desired composition of the sulfide-based solid electrolyte. More specifically, therefore, the mixture may be obtained by mixing lithium sulfide, phosphorus pentasulfide, a halogen compound, and an alkaline earth metal compound or by mixing lithium sulfide, phosphorus pentasulfide, and an alkaline earth metal compound.

The halogen compound may be a compound represented by LiHa. In one aspect, the halogen compound may be selected from the group consisting of LiCl, LiBr, and a combination thereof.

The alkaline earth metal compound may be MeHa₂ or MeS. MeHa₂ may be selected from the group consisting of MgCl₂, MgBr₂, CaCl₂, CaBr₂, and combinations thereof. MeS may be selected from the group consisting of MgS, CaS, and a combination thereof.

The step of pulverizing the mixture is a step of applying external force to the mixture to change the mixture into an amorphous state.

The step of pulverizing the mixture may be dry pulverization using a ball mill, a bead mill, or a homogenizer. However, the present disclosure is not limited thereto. The step of pulverizing the mixture may be wet pulverization using an appropriate amount of solvent and zirconia balls. Pulverization conditions, such as the pulverization speed and the pulverization time, may be appropriately changed based on the manufacturing environment and apparatus. The pulverization conditions are not particularly restricted, as long as the mixture is sufficiently pulverized so as to be amorphous.

The step of thermally treating the pulverized mixture is a step of applying heat to the amorphous pulverized mixture in order to change the mixture into a crystalline state. At this step, a crystalline phase having an argyrodite-based crystalline structure is formed.

The heat treatment may be performed at 400 to 600° C. for 3 to 24 hours. Only in the case in which the heat treatment temperature and time satisfy the above-defined conditions, a crystalline phase having an argyrodite-based crystalline structure may be formed in the state in which the pulverized mixture is not deteriorated.

An all-solid-state battery according to the present disclosure includes a positive electrode, a negative electrode, and a solid electrolyte layer disposed between the positive electrode and the negative electrode. In addition, at least one of the positive electrode, the negative electrode, and the solid electrolyte layer includes the sulfide-based solid electrolyte represented by Chemical Formula 1 above.

The positive electrode may include a positive electrode active material, a conductive agent, and the sulfide-based solid electrolyte. The positive electrode may further include a binder.

For example, the positive electrode active material may be an oxide active material or a sulfide active material, although the positive electrode active material is not particularly restricted.

The oxide active material may be a rock-salt layer type active material such as LiCoO₂, LiMnO₂, LiNiO₂, LiVO₂, or LiNi_{0.6}Co_{0.2}Mn_{0.2}O₂, a spinel type active material such as LiMn₂O₄ or Li(Ni_{0.5}Mn_{1.5})O₄, an inverse-spinel type active material such as LiNiVO₄ or LiCoVO₄, an olivine type active material such as LiFePO4, LiMnPO₄, LiCoPO₄, or LiNiPO₄, a silicon-containing active material such as Li₂FeSiO₄ or Li₂MnSiO₄, a rock-salt layer type active material having a portion of a transition metal substituted by a different kind of metal, such as LiNi_{0.8}Co_{(0.2-x)}AlₓO₂(0<x<0.2), a spinel type active material having a portion of a transition metal substituted by a different kind of metal, such as Li₁₊ₓMn_{2-x-y}M_{y}O₄ (M being at least one of Al, Mg, Co, Fe, Ni, and Zn, and 0<x+y <2), or lithium titanate such as Li₄Ti₅O₁₂.

The sulfide active material may be copper chevrel, ion sulfide, cobalt sulfide, or nickel sulfide.

The conductive agent is a component that forms an electron conduction path in the electrode. The conductive agent may be a sp² carbon material, such as carbon black, Super-P, conductive graphite, ethylene black, or carbon nanotubes, or graphene.

The sulfide-based solid electrolyte was described previously, and therefore a detailed description thereof will be omitted. However, the positive electrode may further include another sulfide-based solid electrolyte in addition to the above-described sulfide-based solid electrolyte. The additional sulfide-based solid electrolyte may be Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are positive integers, and Z is one of Ge, Zn, and Ga), Li₂S—GeS₂, Li₂S—SiS₂—Li₃PO₄, Li₂S—SiS₂—LiₓMO_{y} (where x and y are positive integers, and M is one of P, Si, Ge, B, Al, Ga, and In), or Li₁₀GeP₂S₁₂.

The solid electrolyte layer may include the sulfide-based solid electrolyte represented by Chemical Formula 1 above. The solid electrolyte layer may further include a binder.

The negative electrode may be a metal negative electrode or a composite negative electrode.

The metal negative electrode may be lithium foil or indium foil.

The composite negative electrode may include a negative electrode active material, a conductive agent, and the sulfide-based solid electrolyte. The composite negative electrode may further include a binder.

For example, the negative electrode active material may be a carbon active material or a metal active material, although the negative electrode active material is not particularly restricted.

The carbon active material may be mesocarbon microbeads (MCMB), graphite such as highly ordered pyrolytic graphite (HOPG), or amorphous carbon such as hard carbon or soft carbon.

The metal active material may be In, Al, Si, Sn, or an alloy including at least one thereof.

The conductive agent and the sulfide-based solid electrolyte were described previously, and therefore a detailed description thereof will be omitted.

Hereinafter, the present disclosure will be described in more detail with reference to concrete examples. However, the following examples are merely illustrations to assist in understanding the present disclosure, and the present disclosure is not limited by the following examples.

### EXAMPLES AND COMPARATIVE EXAMPLE

Sulfide-based solid electrolytes having the compositions shown in Table 1 below were manufactured.

Specifically, lithium sulfide, phosphorus pentasulfide, an alkaline earth metal compound, and/or a halogen compound were weighed and mixed at molar ratios based on the compositions shown in Table 1 below to prepare mixtures.

In group A of Table 1, lithium sulfide, phosphorus pentasulfide, MgCl₂ (the alkaline earth metal compound), and LiCl (the halogen compound) were used as raw materials. In the case in which MgCl₂ is added, LiCl may not be used depending on the desired composition of the sulfide-based solid electrolyte, as previously described.

In group B of Table 1, lithium sulfide, phosphorus pentasulfide, MgS (the alkaline earth metal compound), and LiCl (the halogen compound) were used as the raw materials.

In group C of Table 1, lithium sulfide, phosphorus pentasulfide, CaCl₂ (the alkaline earth metal compound), and LiCl (the halogen compound) were used as the raw materials.

In the case in which CaCl₂ is added, LiCl may not be used depending on the desired composition of the sulfide-based solid electrolyte, as previously described.

In Comparative Example of Table 1, lithium sulfide, phosphorus pentasulfide, and LiCl (the halogen compound) were used as the raw materials.

The mixtures were pulverized through mechanical milling. Specifically, the mixtures were pulverized at about 300 RPM for about 24 hours.

The pulverized mixtures were thermally treated at a temperature of about 550° C. for about 5 hours to obtain sulfide-based solid electrolytes having compositions according to Examples 1 to 16 and Comparative Example.

TABLE 1

| | | Raw composition ratio [mol %] | | | | | | | |
|---|---|---|---|---|---|---|---|---|---|
| | | | | | Alkaline | | | | |
| Example/ | | | | | earth metal | | | | Ionic |
| Comparative | | | | | compound | | Composition | Crystalline | conductivity |
| Example | | Li₂S | P₂S₅ | LiCl | * | x | formula | phase | [mS/cm] |
| Example | 1 | 63.29 | 12.66 | 22.78 | 1.27 | 0.05 | Li_{5.9}Mg_{0.05}PS₅Cl | Argyrodite | 2.23 |
| (Group A) | 2 | 64.10 | 12.82 | 20.51 | 2.56 | 0.10 | Li_{5.8}Mg₀₁₀PS₅Cl | Argyrodite | 1.57 |
| | 3 | 64.94 | 12.99 | 18.18 | 3.90 | 0.15 | Li_{5.7}Mg_{0.15}PS₅Cl | Argyrodite | 1.45 |
| | 4 | 65.79 | 13.16 | 15.79 | 5.26 | 0.20 | Li_{5.6}Mg_{0.20}PS₅Cl | Argyrodite | 0.94 |
| | 5 | 71.43 | 14.29 | 0.00 | 14.29 | 0.50 | Li₅Mg_{0.50}PS₅Cl | Argyrodite | 0.81 |
| Example | 6 | 61.25 | 12.50 | 25.00 | 1.25 | 0.05 | Li_{5.9}Mg_{0.05}PS₅Cl | Argyrodite | 2.01 |
| (Group B) | 7 | 60.00 | 12.50 | 25.00 | 2.50 | 0.10 | Li_{5.8}Mg_{0.10}PS₅Cl | Argyrodite | 1.72 |
| | 8 | 58.75 | 12.50 | 25.00 | 3.75 | 0.15 | Li_{5.7}Mg_{0.15}PS₅Cl | Argyrodite | 1.56 |
| | 9 | 57.50 | 12.50 | 25.00 | 5.00 | 0.20 | Li_{5.6}Mg_{0.20}PS₅Cl | Argyrodite | 1.32 |
| Example | 10 | 62.89 | 12.58 | 23.90 | 0.63 | 0.025 | Li_{5.9}Ca_{0.025}PS₅Cl | Argyrodite | 3.18 |
| (Group C) | 11 | 63.29 | 12.66 | 22.78 | 1.27 | 0.050 | Li_{5.9}Ca_{0.050}PS₅Cl | Argyrodite | 3.35 |
| | 12 | 63.69 | 12.74 | 21.66 | 1.91 | 0.075 | Li_{5.8}Ca_{0.075}PS₅Cl | Argyrodite | 3.17 |
| | 13 | 64.10 | 12.82 | 20.51 | 2.56 | 0.10 | Li_{5.9}Ca_{0.10}PS₅Cl | Argyrodite | 2.92 |
| | 14 | 64.94 | 12.99 | 18.18 | 3.90 | 0.15 | Li_{5.7}Ca_{0.15}PS₅Cl | Argyrodite | 2.67 |
| | 15 | 65.79 | 13.16 | 15.79 | 5.26 | 0.20 | Li_{5.6}Ca_{0.20}PS₅Cl | Argyrodite | 2.63 |
| | 16 | 71.43 | 14.29 | 0.00 | 14.29 | 0.50 | Li₅Ca_{0.50}PS₅Cl | Argyrodite | 2.23 |

| | | | | | | | | |
|---|---|---|---|---|---|---|---|---|
| Comparative | 62.5 | 12.5 | 25 | 0 | 0 | Li₆PS₅Cl | Argyrodite | 1.14 |
| Example | | | | | | | | |

* The alkaline earth metal compound in group A is MgCl₂, the alkaline earth metal compound in group B is MgS, and the alkaline earth metal compound in group C is CaCl₂.

### Experimental Example 1

### XRD Analysis

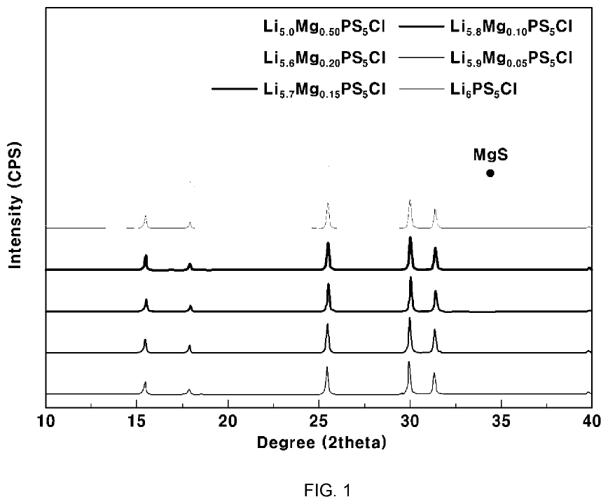

XRD analysis was performed on the sulfide-based solid electrolytes according to Examples 1 to 16 in order to analyze the crystalline structure of each of the sulfide-based solid electrolytes. The results are shown in Table 1 above and in FIGS. 1 to 3.

Referring to FIG. 1, it can be seen that all of the sulfide-based solid electrolytes according to Examples 1 to 5 exhibited the same peak as Comparative Example having the crystalline phase of the argyrodite-based crystalline structure. In the case of Example 5 having x of 0.5, a small amount of MgS was precipitated, and therefore a peak corresponding thereto was observed.

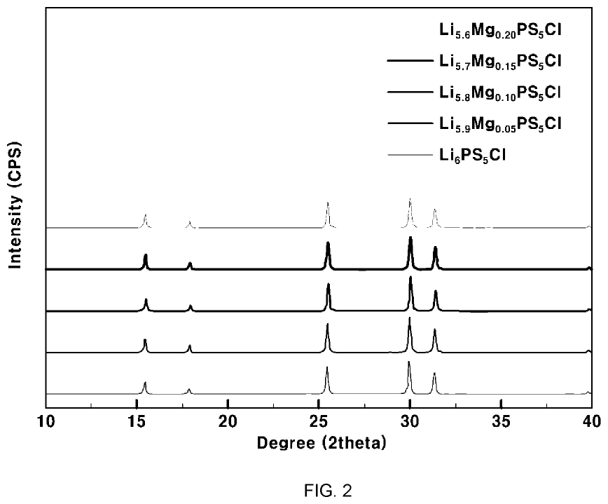

Referring to FIG. 2, it can be seen that all of the sulfide-based solid electrolytes according to Examples 6 to 9 exhibited the same peak as Comparative Example. In addition, unreacted impurities, such as Li₂S or LiCl, were not observed.

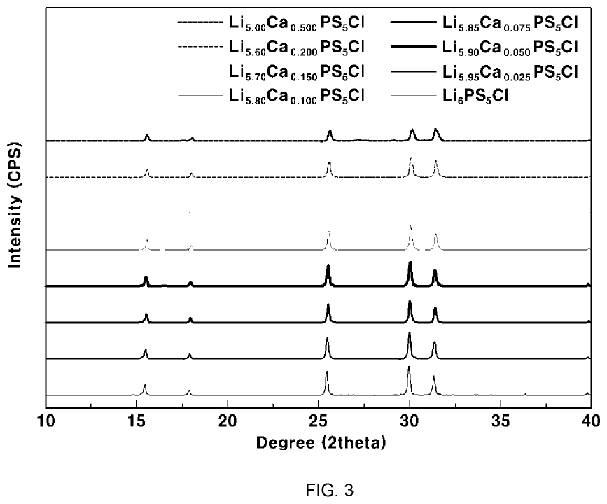

Referring to FIG. 3, it can be seen that all of the sulfide-based solid electrolytes according to Examples 10 to 15 exhibited the same peak as Comparative Example.

It can be seen from the above results that the sulfide-based solid electrolyte according to the present disclosure has the same argyrodite-based crystalline structure as the sulfide-based solid electrolyte according to Comparative Example, represented by Li₆PS₅Cl.

### Experimental Example 2

### Measurement of Ionic Conductivity

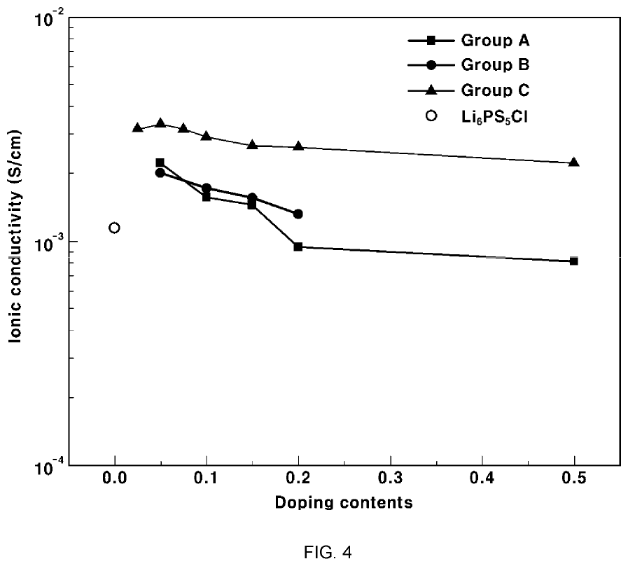

The ionic conductivity of each of the sulfide-based solid electrolytes according to Examples 1 to 16 and Comparative Example was measured. Specifically, each of the sulfide-based solid electrolytes was compressed to form a sample for measurement (having a diameter of 13 mm and a thickness of 1 to 1.5 mm). An alternating-current potential of 10 mV was applied to the sample in an oven having an ambient temperature maintained therein, and then a frequency sweep of 1×10⁶ to 1 Hz was performed to measure an impedance value, from which ionic conductivity was determined. The results are shown in Table 1 above and in FIG. 4.

Referring to these, it can be seen that the sulfide-based solid electrolytes according to Examples exhibited higher ionic conductivity than the sulfide-based solid electrolyte according to Comparative Example, except for some of the Examples in group A. In particular, Example 11 in group C exhibited an ionic conductivity of up to 3.35mS/cm.

### Experimental Example 3

### Evaluation of Voltage Stability

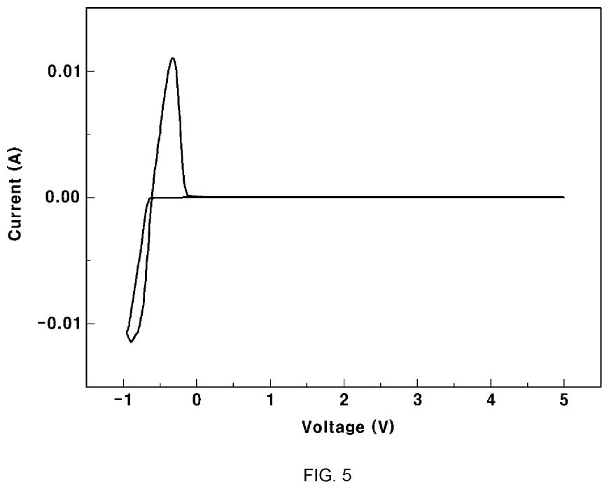

The voltage stability of the sulfide-based solid electrolyte according to Example 11, having the highest ionic conductivity, was evaluated. An indium metal was attached to one surface of the sample of the sulfide-based solid electrolytes, as in Experimental Example 2, and the voltage stability of the sulfide-based solid electrolyte in a range of −1 to 5V was measured under a condition of 20 mV/s. The results are shown in FIG. 5.

Referring to this figure, it can be seen that no decomposition reaction occurred up to a high voltage of 5V. In the case in which the sulfide-based solid electrolyte according to the present disclosure is used, therefore, it is possible to obtain an all-solid-state battery that exhibits high voltage stability.

### Experimental Example 4

### Capacity and Lifespan Evaluation

An all-solid-state battery was manufactured using the sulfide-based solid electrolyte according to Example 11, and the capacity of the all-solid-state battery was measured.

Specifically, 0.2 g of the sulfide-based solid electrolyte was pelletized using a mold having a diameter of 161) to manufacture a solid electrolyte layer. 0.02 g of a mixture, including 70 wt % of LiNi_{0.6}Co_{0.2}Mn_{0.2}O₂ (a positive electrode active material), 28 wt % of the sulfide-based solid electrolyte, and 2 wt% of Super-P (a conductive agent), was applied to one surface of the solid electrolyte layer to manufacture a positive electrode. Indium foil was attached to the other surface of the solid electrolyte layer to manufacture a negative electrode.

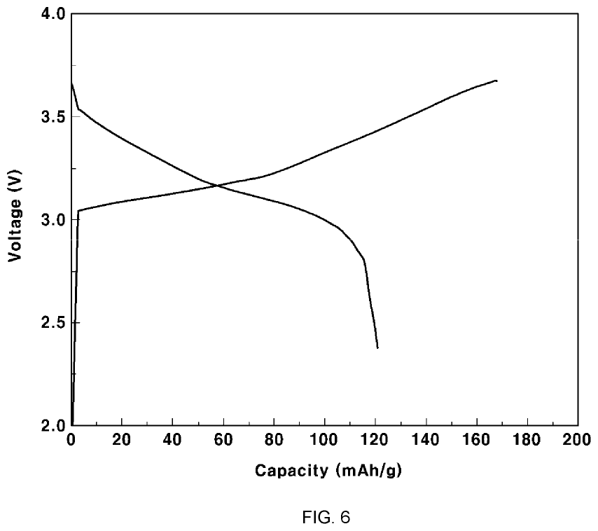

The all-solid-state battery manufactured as described above was charged and discharged under conditions of a C rate of 0.1 C and a voltage of 3.0 to 4.3V, compared to Li. The results are shown in FIG. 6. Referring to this figure, the measured capacity of the all-solid-state battery was 120.76 mAh/g.

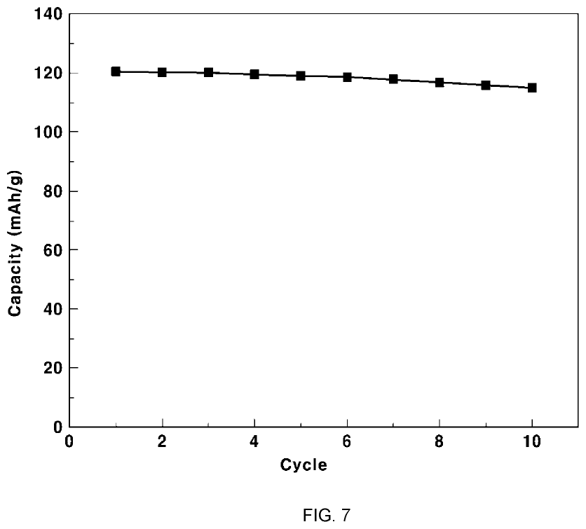

The all-solid-state battery was repeatedly charged and discharged to measure a change in the capacity thereof. The results are shown in FIG. 7. Referring to this figure, it can be seen that the all-solid-state battery behaved stably without a great change in the capacity thereof even after the all-solid-state battery was charged and discharged 10 times.

As is apparent from the foregoing, the sulfide-based solid electrolyte according to the present disclosure has a novel composition. The sulfide-based solid electrolyte exhibits high voltage stability and ionic conductivity. Consequently, it is possible to obtain an all-solid-state battery having a large capacity and stable behavior using the sulfide-based solid electrolyte.

The effects of the present disclosure are not limited to those mentioned above. It should be understood that the effects of the present disclosure include all effects that can be inferred from the foregoing description of the present disclosure.

The disclosure has been made in detail. However, it will be appreciated by those skilled in the art that changes may be made without departing from the principles and spirit of the disclosure.

What is claimed is:

1. A sulfide-based solid electrolyte represented by Chemical Formula 1 below.
Li₆₋₂ₓMeₓPS₅Ha [Chemical Formula 1]
wherein Me is an alkaline earth metal element, Ha is a halogen element, and 0<x—0.5.

2. The sulfide-based solid electrolyte of claim 1, wherein the sulfide-based solid electrolyte comprises a crystalline phase having an argyrodite-based crystalline structure.

3. The sulfide-based solid electrolyte of claim 1, wherein Me is an alkaline earth metal element selected from a group consisting of Ca, Mg, and a combination thereof.

4. The sulfide-based solid electrolyte of claim 1, wherein the Ha is a halogen element selected from a group consisting of Cl, Br, and a combination thereof.

5. An all-solid-state battery comprising:
a positive electrode;
a negative electrode; and
a solid electrolyte layer disposed between the positive electrode and the negative electrode, wherein
at least one of the positive electrode, the negative electrode, and the solid electrolyte layer comprises the sulfide-based solid electrolyte of claim 1.

6. A method of manufacturing a sulfide-based solid electrolyte, the method comprising:
preparing a mixture of lithium sulfide, phosphorus pentasulfide, and a compound selected from a group consisting of a halogen compound, an alkaline earth metal compound, and a combination thereof;
pulverizing the mixture to yield a pulverized mixture; and
thermally treating the pulverized mixture.

7. The method of claim 6, wherein the sulfide-based solid electrolyte is represented by Chemical Formula 1 below.
Li₆₋₂ₓMeₓPS₅Ha [Chemical Formula 1]
wherein Me is an alkaline earth metal element, Ha is a halogen element, and 0<x≤0.5.

8. The method of claim 6, wherein
the halogen compound is LiHa, and
the Ha is a halogen element selected from a group consisting of Cl, Br, and a combination thereof.

9. The method of claim 6, wherein
the alkaline earth metal compound is MeHa₂ or MeS,
the Me is an alkaline earth metal element selected from a group consisting of Ca, Mg, and a combination thereof, and
the Ha is a halogen element selected from a group consisting of Cl, Br, and a combination thereof.

10. The method of claim 6, wherein the sulfide-based solid electrolyte comprises a crystalline phase having an argyrodite-based crystalline structure.

11. The method of claim 6, wherein thermally treating is performed at 400 to 600° C. for 3 to 24 hours.
